(19) United States
(12) Patent Application Publication
(10) Pub. No.: US 2006/0093428 A1
(43) Pub. Date: May 4, 2006

(54) Hanging file

(76) Inventors: Robert C. Gorin, Newton, MA (US); Thomas E. Salisbury, Oakland, CA (US)

Correspondence Address: FISH & RICHARDSON PC, P.O. BOX 1022, MINNEAPOLIS, MN, 55440-1022, US

(21) Appl. No.: 10/976,679

(22) Filed: Oct. 29, 2004

(51) Int. Cl. B42F 13/00

(52) U.S. Cl. 402/75

(57) ABSTRACT

A device binds pages each of which has at least one hole, the device including a binding structure to pass through the holes of the pages, a holding structure to hold the device on a ring of a ring binder, and a hanging structure to suspend the device in a hanging file.

### BACKGROUND

This description relates to page binding.

A variety of devices have been used and proposed for binding pages either temporarily or permanently. In one proposed example, holed pages may be bound in a plastic spine and the spine can be suspended on the parallel rails of a hanging file drawer by two fingers that can be extended from opposite ends of the spine and rest on the rails.

### SUMMARY

In general, in one aspect, a device binds pages each of which has at least one hole, the device including a binding structure to pass through the holes of the pages, a holding structure to hold the device on a ring of a ring binder, and a hanging structure to suspend the device in a hanging file.

Implementations may include one or more of the following features. The binding structure includes a post and a hole. The post has an end configured to mate with the hole. The holding structure includes a hole though which the ring passes. The holding structure includes a hole through which the ring passes and the hole is within the post. The hanging structure includes a hanger that can be extended and retracted with respect to the device. The hanger includes friction elements to facilitate the hanger being extended and retracted. The hanging structure is configured so that the device projects no more than about 3/16″ above the plane of supporting rails of the hanging file. The device includes a surface that is exposed to a viewer from above the hanging file when the device is suspended, the surface being generally perpendicular to the pages at their bound edges, the hanging structure being offset to cause the exposed surface to be tilted relative to the plane of supporting rails of the hanging file. The device bears indicia that distinguish the device from other devices having the same structures. The indicia comprises color. The hanging structure is removable from the device.

In general, in another aspect, a device binds three-hole paper, the device including three posts and three corresponding holes in which the three posts respectively mate through the three holes of the paper, the three posts having bores to receive respectively the three rings of a three-ring binder, and two hangers that can be extended and retracted with respect to the device to hang the device with paper in a hanging file drawer or box.

In general, other aspects include methods of making and using the device, systems that include the device, and structures that are only portions of the device.

Other advantages and features will become apparent from the following description and from the claims.

### DESCRIPTION OF DRAWINGS

FIGS. 1, 2A, and 2B are three-dimensional views, respectively, of an opened file binder, and a hanger viewed from two different directions.

FIGS. 3, 4, and 6 are three-dimensional views, respectively, of a file binder and paper, a file binder in a three-ring binder, and a binder post.

FIG. 5A is a partial side view of a file binder and paper hanging from a rail with an end of a hanger of the file binder cut away.

FIG. 5B is a partial end view of a file binder and paper hanging from a rail.

FIG. 5C is a perspective view of a tab.

### DETAILED DESCRIPTION

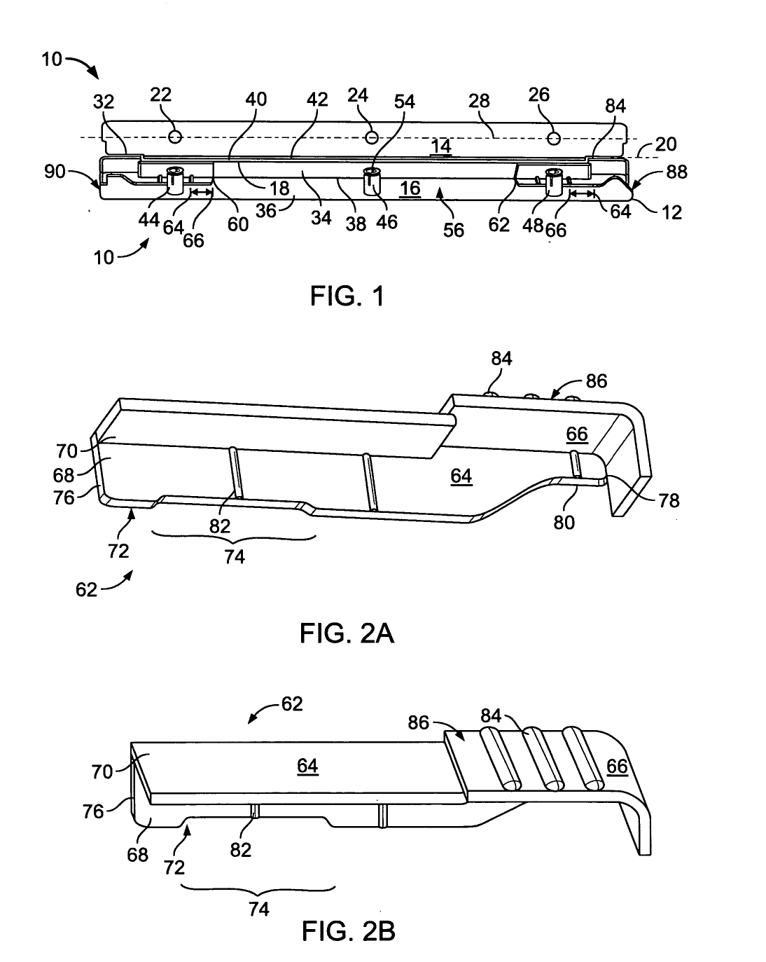

As shown in FIG. 1, one example of a file binder 10 has a molded plastic body 12 that includes a two relatively rigid pieces 14, 16 connected along a common edge by a molded-in hinge 18 to permit the two pieces to be opened and closed about an axis 20.

In the example of FIG. 1, one of the rigid pieces 14 is a flat rectangle that is ¾″ wide by about 11¼″ long and is about 1/16″ thick. Three ¼″ holes 22, 24, 26 are arranged in a line 28 on piece 14 and spaced apart by 4¼″ to match the spacing of the drilled holes in typical 3-hole drilled 8½″ by 11″ paper. Line 28 is about ½″ from the hinge 18. The comers of piece 14 are rounded and the ends of piece 14 include insets 30, 32 to accommodate hangers to be described later. The hinge 18 is about 9⅝″ long.

In the example of FIG. 1, the other rigid piece 16 is formed of two subpieces 34, 36 joined permanently along a common corner 38. Subpiece 34 is about ½″ wide by 9⅝″ long. The edge 40 of subpiece 34 that joins the hinge 18 is chamfered at 45 degrees as is the edge 42 of piece 14 so that the two pieces can be closed without obstruction to a position in which they are at 90 degrees to one another.

The subpiece 36 has a shape and dimensions that are essentially the same as those of piece 14. Three posts 44, 46, and 48 project perpendicularly about 7/16″ from a surface 50 of subpiece 36 towards the holes 22, 24, 26. The posts are spaced in the same way as the holes and the line 52 along which the posts are spaced is about the same distance from the hinge as are the three holes.

Each post has an outer diameter of about ¼″ which is small enough to fit within a typical hole punched or drilled in loose-leaf paper, which may have a diameter of, for example, 5/16″. Each post also has an inner hole along its length that is, for example, 3/16″ in diameter. The length and bore of the post hole are selected to permit a curved steel ring of a typical three-ring binder to pass freely within the hole.

As shown in FIG. 6, at the free end of each of the posts is a snapping mechanism 54 that enables the post to be snapped into and held within a corresponding one of the holes 22, 24, 26. The snapping mechanism includes a section 56 that is of slightly smaller diameter than the main part of the post, and an annular lip 58 on the end of the post that is slightly larger in diameter than the hole into which the post will be snapped. Each post also has two slits that extend about ¼″ along the length of the post from the free end and provide resiliency to the snapping mechanism.

In the example of FIG. 1, the file binder also includes two separate molded plastic hangers 60, 62 that are mounted in a way that permits them to be slid back and forth relative to the length of the binder in the directions shown by arrows 64, 66. The shapes of the plastic hangers 60, 62 are mirror images of one another and we only describe one in detail with respect to FIG. 2.

In the example of FIGS. 2A and 2B, hanger 62 includes a body 64 and a finger grip 66. The body 64 has two sides 68, 70 that are perpendicular to one another. Side 68 in this example is ⅜″ by 1½″ and is about 1/16″ thick. Side 70 is a little less than 1/16″ thick, ¼″ wide, and about 2 3/16″ long. A contoured edge 72 of the side 68 includes an inset 74 that extends about ⅝″ along the length of the side beginning at a point about 3/16″ from an end 76. The inset is about 1/32″ deep. At the other end 78 of the side 68 the contour steps back to form an edge 80 which rides on a bar of a hanging file drawer, for example, as explained later. The distance between the edge 80 and a top surface of the hanger (and of the file binder subpiece 34) is about 3/16″ in this example. Side 68 has reinforcing ribs 82.

In the example of FIGS. 2A and 2B, the finger grip 66 is about ½″ wide, ¾″ long, and 1/16″ thick. Three 1/32″ high ribs 84 provide friction against a finger of a user when the hanger is extended or retracted from the file binder.

The hanger is configured so that when it is retracted fully, the outer contour 86 of the finger grip matches the flat outer surface of subpiece 34 and the contours of the ends 88, 90 of the subpiece 36 and the piece 14.

Each hanger can be easily mounted in or removed from the file binder when the file binder is open. Then the hanger is mounted, the post 48 (for example) rides along the edge of the inset 74 in such a way that when the hanger is moved in direction 66 towards the body of the file binder, it cannot be moved past a position in which the finger grip nestles within the end of the file binder. Conversely, when the hanger is moved away from the body of the file binder, it cannot be extended easily farther than about ½″ before it is stopped.

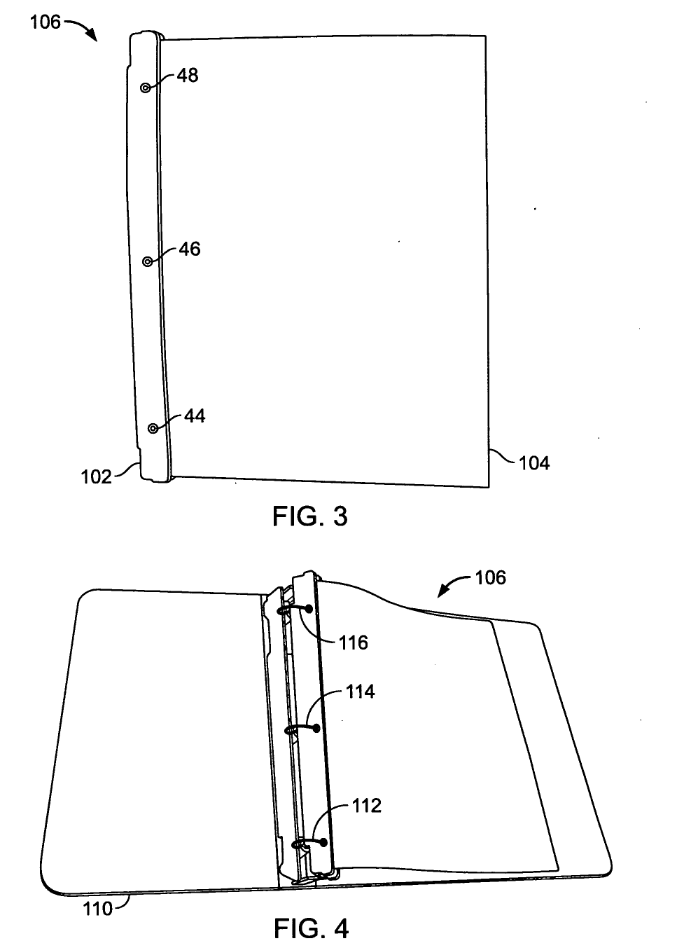

In one example of how the binder can be used, shown in FIG. 3, the file binder 102 holds a sheaf 104 of three-hole drilled paper as a notebook 106. To make use of the binder in this way, the binder is opened, the hangers may (but need not) be removed, the paper is loaded onto the posts, and the binder is closed by snapping the three posts into the three corresponding holes. The configuration of the hangers provides clearance between the side 70 of each hanger and the piece 14 to accommodate the edges of the paper being bound. The notebook could be used permanently this way or the number and selection of papers that are bound by the binder can be changed at any time by opening the binder, making the change, and then re-closing it. As a notebook, the binder provides a secure, sturdy, attractive spine for the enclosed paper.

In another example of how the file binder can be used, shown in FIG. 4, the notebook 106 formed by the file binder and bound paper can be mounted in a typical three-ring binder 110 by opening the rings and inserting the entire notebook as a unit over the three curved steel rings 112, 114, 116. As mentioned earlier the holes in the posts of the file binder are configured to permit the binder rings to pass freely.

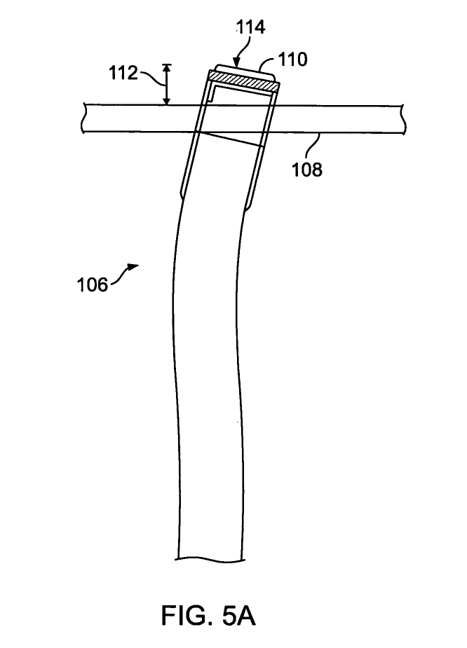

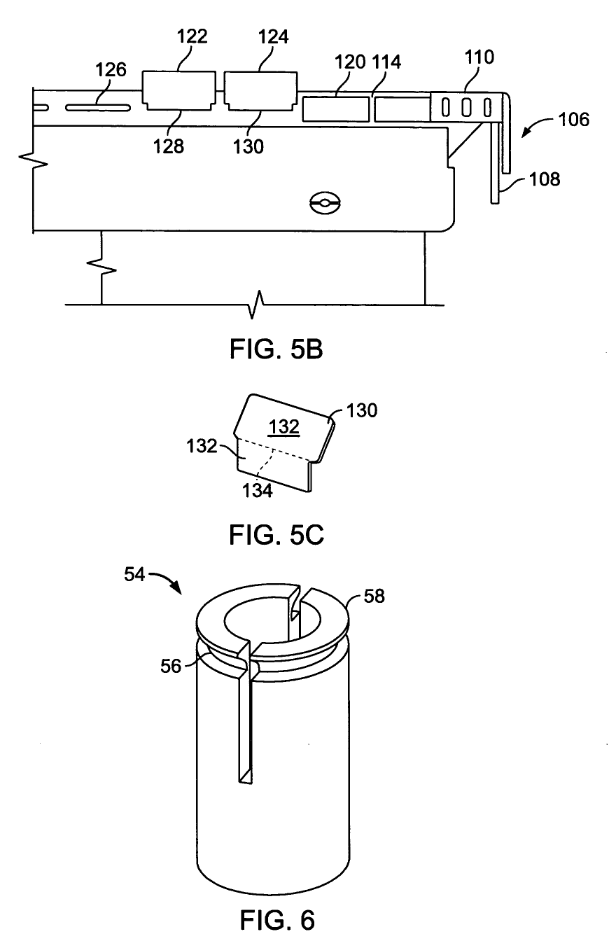

In another example of how the file binder can be used, shown in FIGS. 5A and 5B, the notebook 106 formed by the file binder and bound paper can be hung in a typical hanging file drawer of the kind that has two parallel rails 108 (only one is shown) that allow hanging files to be suspended and moved back and forth for access. For this purpose, the hangers 110 (only one shown) are extended to their outer position (if hangers have not previously been mounted into the binder, the binder is opened and the hangers are mounted and then extended). When the notebook is suspended in this way, the file binder projects only a small distance 112 above the rails (for example, about 3/16″) and therefore can be mounted into any sort of hanging file drawer, box or cabinet.

When hangers are included in a file binder, it can easily be transferred from any of the three uses to any other. For example, the file binder could be removed from a hanging file drawer and used as a notebook. Also, the hangers could be retracted and the notebook inserted into a three-ring binder.

Because the side 74 and edge 80 are offset to one side from the center of gravity of the file binder, when the binder is suspended, it has a natural tendency to tilt (as shown in FIG. 5A) so that the outer surface 114 of the subpiece 36 does not lie in a plane parallel to the plane of the two rails, but rather is tilted so that the surface is easier to read from one end of the drawer.

By coloring the file binder and the hangers using different colors, a variety of color codes and color coding can be provided for the notebooks that are formed by the file binders. The file binder and the hangers could all be of one color for a given notebook, and a different color for another notebook. Or the file binder could be of one color and both of the hangers could be of a different color. Or the file binder could be of one color, and the two hangers could be of second and third, different colors, all in a way that color codes the notebooks. Other indicia could be used to differentiate different notebooks including characters or symbols on the file binder and/or on one or more of the hangers. Symbols and characters could be combined with colors to provide more combinations.

Colors and other indicia could be formed into the plastic or added using labels (such as label 120) or other coverings. Tabs 122, 124 could be added to the file binders to label them. The tabs could be color coded or other indicia could be used to differentiate different tabs. The labels and tabs could accept handwritten or printed words or symbols. The tabs could be inserted into and removed easily from slots 126, 128, 130 all along (or in selected locations along) the outer surface 114 of the spine.

As shown in FIG. 5C, a tab 122 could include a visible face 130 that is formed at an angle 134 to a vertical finger 132 for easy viewing. The finger 132 is to be inserted into one of the slots 126, 128, 130. Longer tabs could span more than one of the slots, and shorter tabs could be inserted in pairs, for example, into a given slot.

Other embodiments are within the scope of the following claims.

For example, a wide variety of other configurations, sizes, materials, configurations, number, and shapes could be used for the pieces and subpieces of the file binder and the hangers. The number, size, and location of holes and posts differ for binding other kinds of paper.

Other structures can be used to pass through the holes of the pages, to hold the file binder on the rings of the ring-binder, and to suspend the file binder in a hanging file. The portions of the file binder and hangers that pass through the holes, hold the file binder on the rings, and suspend the file binder need not be separate structures but could be combined in pairs or altogether to form the device.

What is claimed is:

1. An apparatus comprising
a device to bind pages each of which has at least one hole, the device including
a binding structure to pass through the holes of the pages,
a holding structure to hold the device on a ring of a ring binder, and
a hanging structure to suspend the device in a hanging file.

2. The apparatus of claim 1 in which the binding structure comprises a post and a hole.

3. The apparatus of claim 2 in which the post has an end configured to mate with the hole.

4. The apparatus of claim 1 in which the holding structure comprises a hole though which the ring passes.

5. The apparatus of claim 2 in which the holding structure comprises a hole through which the ring passes and the hole is within the post.

6. The apparatus of claim 1 in which the hanging structure comprises a hanger that can be extended and retracted with respect to the device.

7. The apparatus of claim 6 in which the hanger includes friction elements to facilitate the hanger being extended and retracted.

8. The apparatus of claim 1 in which the hanging structure is configured so that the device projects no more than about 3/16″ above the plane of supporting rails of the hanging file.

9. The apparatus of claim 1 in which the device includes a surface that is exposed to a viewer from above the hanging file when the device is suspended, the surface being generally perpendicular to the pages at their bound edges, the hanging structure being offset to cause the exposed surface to be tilted relative to the plane of supporting rails of the hanging file.

10. The apparatus of claim 1 in which the device bears indicia that distinguish the device from other devices having the same structures.

11. The apparatus of claim 1 in which the hanging structure is removable from the device.

12. The apparatus of claim 10 in which the indicia comprises color.

13. The apparatus of claim 1 in which the device also includes structure to receive identification tabs.

14. An apparatus comprising
a device to bind three-hole paper, the device including
three posts and three corresponding holes in which the three posts respectively mate through the three holes of the paper,
the three posts having bores to receive respectively the three rings of a three-ring binder, and
two hangers that can be extended and retracted with respect to the device to hang the device with paper in a hanging file drawer or box.

15. A method comprising
binding a set of holed pages into a binding device that includes posts passing through the holes, and
mounting the bound pages in a ring binder by pass one or more rings of the binder through holes in the posts.
